(19) United States
(12) Patent Application Publication
(10) Pub. No.: US 2024/0117978 A1
(43) Pub. Date: Apr. 11, 2024

(54) VENTILATOR

(71) Applicant: Mitsubishi Electric Corporation, Tokyo (JP)

(72) Inventors: Mamoru HAMADA, Tokyo (JP); Hayato HORIE, Tokyo (JP)

(21) Appl. No.: 18/546,191

(22) PCT Filed: Apr. 21, 2021
(86) PCT No.: PCT/JP2021/016205

§ 371 Date: Aug. 11, 2023

(51) Int. Cl. F24F 3/14; B01D 53/06; B01D 53/26; F24F 3/147

(52) U.S. Cl. CPC F24F 3/1423; B01D 53/06; B01D 53/261; F24F 3/147; B01D 2257/80; B01D 2258/06; B01D 2259/40088; F24F 2203/1024; F24F 2203/1032; F24F 2221/14; F24F 2221/17

(57) ABSTRACT

A ventilator according to the present disclosure includes a first air flow path that draws in indoor air and blows out air into an indoor space, a second air flow path that draws in indoor air and blows out air to an outdoor space, first blower means placed in the first air flow path, second blower means placed in the second air flow path, a desiccant rotor which is placed across the first air flow path and the second air flow path and in which a portion located in the first air flow path and a portion located in the second air flow path are switched over time by rotation, and a first heat exchanger located upstream of the desiccant rotor in the first air flow path.

### CROSS-REFERENCE TO RELATED APPLICATION

This application is a U.S. National Stage Application of International Application No. PCT/JP2021/016205 filed Apr. 21, 2021, the contents of which are incorporated herein by reference.

### TECHNICAL FIELD

The present disclosure relates to ventilators.

### BACKGROUND

In recent years, technologies have been disclosed which can simultaneously perform indoor ventilation and humidity control. Patent Literature 1 discloses a humidity control apparatus that is composed of a first air flow path that draws in indoor air and discharges it to the outside in dehumidification operation, a second air flow path that draws in indoor air and provides air after humidity control to the room, and a desiccant rotor provided across the two air flow paths, and can simultaneously perform ventilation and humidity control.

### PATENT LITERATURE

Patent Literature 1: JP 2018-146217 A

However, in the above humidity control apparatus, indoor air needs to be supplied to the second air flow path in dehumidification operation and outdoor air needs to be supplied to the second air flow path in humidification operation. That is, the supply source of the air to be supplied differs depending on the operating state, so that it may be difficult to secure a route for supplying air to the second air flow path, and on-site implementation workability may be reduced.

### SUMMARY

The present disclosure is made to solve the above problems. An object of the present disclosure is to provide a ventilator that facilitates securing an air flow path and implementation and that can also demonstrate high ventilation functionality and dehumidification and humidification performance.

A ventilator according to the present disclosure includes a first air flow path that draws in indoor air and blows out air into an indoor space, a second air flow path that draws in indoor air and blows out air to an outdoor space, first blower means placed in the first air flow path, second blower means placed in the second air flow path, a desiccant rotor which is placed across the first air flow path and the second air flow path and in which a portion located in the first air flow path and a portion located in the second air flow path are switched over time by rotation, and a first heat exchanger located upstream of the desiccant rotor in the first air flow path.

A ventilator of the present disclosure facilitates installation and can also demonstrate high ventilation functionality and dehumidification and humidification performance regardless of the seasons.

### BRIEF DESCRIPTION OF DRAWINGS

FIG. 1 is a figure illustrating a configuration of a ventilator in Embodiment 1;

FIG. 2 is a figure illustrating an effect of the ventilator in Embodiment 1;

FIG. 3 is a figure illustrating a variation of the ventilator in Embodiment 1;

FIG. 4 is a figure illustrating a variation of the ventilator in Embodiment 1;

FIG. 5 is a figure illustrating an installation example of the ventilator in Embodiment 1;

FIG. 6 is a figure illustrating a configuration of a ventilator in Embodiment 2;

FIG. 7 is a figure illustrating an effect of the ventilator in Embodiment 2;

FIG. 8 is a figure illustrating another effect of the ventilator in Embodiment 2;

FIG. 9 is a figure illustrating a configuration of a ventilator in Embodiment 3;

FIG. 10 is a figure illustrating an effect of the ventilator in Embodiment 3;

FIG. 11 is a figure illustrating another effect of the ventilator in Embodiment 3;

FIG. 12 is a figure illustrating a configuration of a ventilator in Embodiment 4;

FIG. 13 is a figure illustrating an effect of the ventilator in Embodiment 4; and

FIG. 14 is a figure illustrating another effect of the ventilator in Embodiment 4.

### DETAILED DESCRIPTION

Embodiments of the present disclosure will be described hereinafter with reference to the drawings. In the drawings, common elements are denoted by the same reference numeral (1a, 1b, . . . ). In the following description, when there is no need to distinguish common elements individually, the alphabets in the reference signs will be omitted.

The embodiments to be described hereinafter are intended for description and are not intended to limit the scope of the present disclosure. That is, a person skilled in the art can adopt embodiments in which each element or all elements of a ventilator of the present disclosure are replaced with equivalent elements, and these embodiments are also included in the scope of the present disclosure. In other words, the present disclosure is not limited to the embodiments to be described hereinafter, and various modifications are possible without departing from the spirit of the present disclosure.

### Embodiment 1

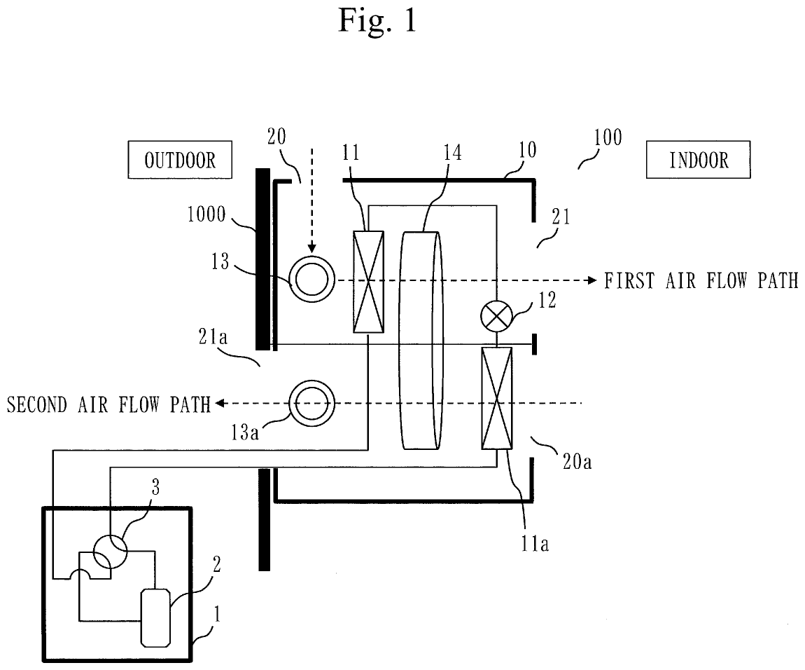

FIG. 1 is a figure illustrating a configuration of a ventilator 100 according to Embodiment 1 of the present disclosure. The ventilator 100 is composed of an outdoor unit 1 installed outdoors and a case 10 that performs indoor ventilation.

In the outdoor unit 1, a compressor 2 and a four-way valve 3 are placed. In the case 10, a first heat exchanger 11, first expansion means 12, a second heat exchanger 11a, first blower means 13, second blower means 13a, and a desiccant rotor 14 are placed. In the case 10, a first air inlet 20, a second air inlet 20a, a first air outlet 21, and a second air outlet 21a are further provided.

The compressor 2, the four-way valve 3, the first heat exchanger 11, the first expansion means 12, and the second heat exchanger 11a are connected by pipes such as copper pipes so as to form a refrigerant circuit. A heat medium (for example, R32 (difluoromethane)) flows inside the refrigerant circuit. The type of heat medium is not limited in this embodiment.

The compressor 2 is, for example, a rotary compressor. The compressor 2 may be a piston or scroll compressor. The compressor 2 may be operated at the rated frequency, or the frequency may be variably controlled by an inverter installed in a control device (not illustrated).

The four-way valve 3 has a function of switching a flow path, and switches the flow path depending on whether the ventilator 100 performs dehumidification operation or humidification operation. When the dehumidification operation is performed, the four-way valve 3 connects a discharge port of the compressor 2 and the second heat exchanger 11a, and also connects the first heat exchanger 11 and an inlet port of the compressor 2. When the humidification operation is performed, the four-way valve 3 connects the discharge port of the compressor 2 and the first heat exchanger 11, and connects the second heat exchanger 11a and the inlet port of the compressor 2.

The first heat exchanger 11 and the second heat exchanger 11a are, for example, finned tube heat exchangers composed of copper pipes and aluminum fins fixed to the copper pipes. The first heat exchanger 11 and the second heat exchanger 11a exchange heat between a heat medium flowing through the copper pipes and air passing through gaps between the fins. The first heat exchanger 11 is placed in a first air flow path to be described later, and the second heat exchanger 11a is placed in a second air flow path to be described later.

The first expansion means 12 is, for example, a solenoid valve whose opening degree can be controlled. The first expansion means 12 decompresses an inflowing refrigerant at high pressure to the refrigerant at low pressure.

The first blower means 13 draws in indoor air from the first air inlet 20 and causes the indoor air to flow into the first heat exchanger 11 and the desiccant rotor 14. The indoor air exchanges heat with the heat medium flowing through the first heat exchanger 11, and then goes through humidity control in the desiccant rotor 14 and is blown out from the first air outlet 21. That is, the first blower means 13 causes the air to flow through the first air flow path connecting the first air inlet 20 and the first air outlet 21. As the first blower means 13, any means can be used such as a sirocco fan, a propeller fan, or a cross flow fan.

The second blower means 13a draws in indoor air from the second air inlet 20a, and causes the indoor air to flow into the second heat exchanger 11a and the desiccant rotor 14. The indoor air exchanges heat with the heat medium flowing through the second heat exchanger 11a, receives moisture from the desiccant rotor 14 or supplies moisture to the desiccant rotor 14, and then is blown out to the outside from the second air outlet 21a. That is, the second blower means 13a causes the air to flow through the second air flow path connecting the second air inlet 20a and the second air outlet 21a. As the second blower means 13a, any means can be used such as a sirocco fan, a propeller fan, or a cross flow fan, like the first blower means 13.

The desiccant rotor 14 has a disk-shaped base member which has many small through holes in an axial direction and to which an adsorbent to adsorb and desorb moisture is applied. The disc-shaped base member is made of any kind of fibrous material including a metallic fiber such as copper and aluminum, a carbon fiber, a plant fiber such as pulp, a ceramic fiber, and a glass fiber. As the adsorbent, any material can be used such as zeolite, silica gel, activated carbon, or a hydrophilically functionalized polymeric material.

A portion of the desiccant rotor 14 is placed in the first air flow path, and the remaining portion of the desiccant rotor 14 is placed in the second air flow path. The percentage of the desiccant rotor 14 placed in the first air flow path can be set in any manner, and may be half of the desiccant rotor 14, for example. Alternatively, if the desiccant rotor 14 has high moisture adsorption performance and low moisture desorption performance, 30 percent may be placed in the first air flow path and 70 percent may be placed in the second air flow path. Furthermore, the desiccant rotor 14 is connected to a rotation device (not illustrated). The rotation device causes the portion of the desiccant rotor 14 located in the first air flow path and the portion of the desiccant rotor 14 located in the second air flow path to be switched over time.

The ventilator 100 also includes a control device (not illustrated). The control device includes, for example, a central processing unit (CPU), a communication interface, a read only memory (ROM), a random access memory (RAM), and a secondary storage device. These constituent elements are connected with one another through a bus. The communication interface can transmit and receive signals to and from the compressor 2, the four-way valve 3, the first expansion means 12, the first blower means 13, the second blower means 13a, and the rotation device of the desiccant rotor 14 via a network interface card controller (NIC) for wired communication or wireless communication.

The operation of the ventilator 100 will now be described. In the following description, the dehumidification operation of the ventilator 100 will be described first, and then the humidification operation will be described.

In the dehumidification operation, the heat medium at high temperature and high pressure discharged from the compressor 2 flows through the four-way valve 3 and the second heat exchanger 11a in the refrigerant circuit. Then, the heat medium is decompressed to become low temperature and low pressure in the first expansion means 12, and flows through the first heat exchanger 11. The heat medium that has flowed out from the first heat exchanger 11 is drawn into the compressor 2 again via the four-way valve 3.

As the refrigerant circuit operates as described above, the desiccant rotor 14 starts rotating by the rotation device (not illustrated). This causes the portion of the desiccant rotor 14 located in the first air flow path and the portion of the desiccant rotor 14 located in the second air flow path to be switched over time.

Furthermore, the first blower means 13 and the second blower means 13a start operating. The first blower means 13 causes the air to flow through the first air flow path, and the second blower means 13a causes the air to flow through the second air flow path. The conditions of the air in the two air flow paths will be described below.

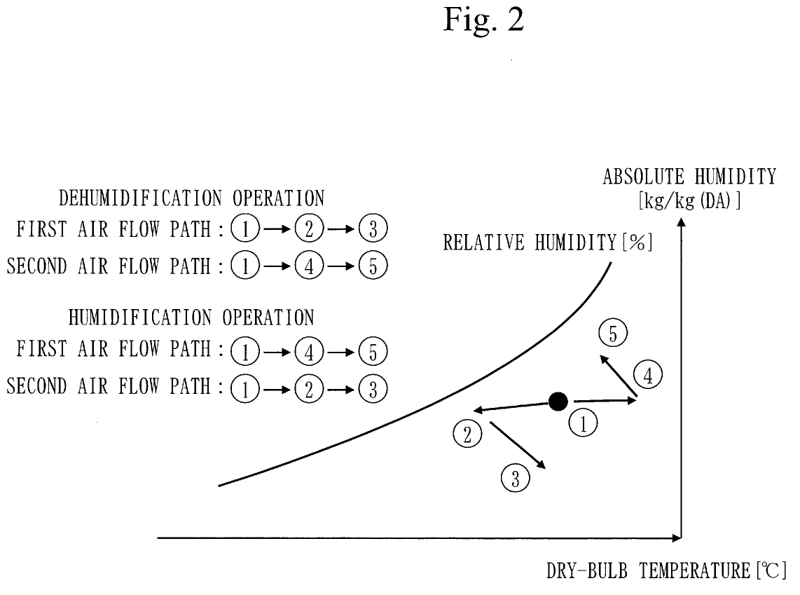

FIG. 2 is a psychrometric chart indicating the conditions of the air in the first and second air flow paths in the dehumidification operation. In the psychrometric chart of FIG. 2, the horizontal axis indicates the dry-bulb temperature [° C.], the vertical axis indicates the absolute humidity [kg/kg(DA)], and the curve in the figure indicates the relative humidity [%]. In FIG. 2, the conditions of the air in the first and second air flow paths are indicated by numbers 1, 2, 3, and so on. The conditions of the air indicated in FIG. 2 are an example, and are not intended to limit the conditions of the air in each situation. FIG. 2 in the present disclosure is intended to describe a tendency of changes in the conditions of the air in the first and second air flow paths.

In the first air flow path, indoor air in condition 1 in the figure is drawn into the case 10 from the first air inlet 20. Then, the air flows into the first heat exchanger 11. At this time, the heat medium at low temperature is flowing through the first heat exchanger 11, so that the inflowing indoor air is cooled and changes to condition 2 in the figure. Furthermore, at this time the absolute humidity of the air also decreases. This is because condensation generally occurs in the vicinity of a heat exchanger even when the relative humidity is less than 100%.

The air that has passed through the first heat exchanger 11 flows into the desiccant rotor 14. The portion of the desiccant rotor 14 located in the first air flow path is dry. Therefore, the desiccant rotor 14 adsorbs moisture contained in the air. This reduces the absolute humidity of the air and dehumidification is performed. When the desiccant rotor 14 adsorbs moisture, adsorption heat is generated and the temperature of the air rises. Due to the above action, the air changes from condition 2 to condition 3 in the figure. The portion of the desiccant rotor 14 that has adsorbed moisture moves to the second air flow path due to rotation.

The rotation speed of the desiccant rotor 14 can be determined in any manner. In general, with a disk-shaped desiccant rotor with many small holes, the efficiency of moisture adsorption and desorption varies according to the rotation speed. Therefore, the rotation speed that maximizes the efficiency may be obtained by experiment or the like, and the desiccant rotor 14 may be rotated at this rotation speed during operation. When the humidity of the indoor air is low and dehumidification is not required, the rotation speed of the desiccant rotor 14 may be reduced or the desiccant rotor 14 may be stopped.

In the dehumidification operation, the conditions of the air change in the second air flow path as described below. The indoor air in condition 1 in FIG. 2 is drawn into the case 10 from the second air inlet 20a, and flows into the second heat exchanger 11a. At this time, the heat medium at high temperature is flowing through the second heat exchanger 11a, so that the air is heated and changes to condition 4.

The air that has passed through the second heat exchanger 11a flows into the desiccant rotor 14. The portion of the desiccant rotor 14 located in the second air flow path has adsorbed moisture. Therefore, moisture desorbs from the desiccant rotor 14 in the second air flow path. This increases the humidity of the air, and the temperature of the air decreases due to desorption heat. As a result, as indicated in FIG. 2, the air changes from condition 4 to condition 5. The air that has passed through the desiccant rotor 14 is discharged to the outside from the second air outlet 21a. The dry portion of the desiccant rotor 14 moves to the first air flow path due to rotation.

The ventilator 100 performs the dehumidification operation by the above operation. The humidification operation of the ventilator 100 will be described next. In the following, description of operation in common with the dehumidification operation will be omitted as appropriate.

In the humidification operation, the heat medium at high temperature and high pressure discharged from the compressor 2 flows through the four-way valve 3 and the first heat exchanger 11. The heat medium that has flowed out from the first heat exchanger 11 flows into the first expansion means 12 to be decompressed. The heat medium that has been decompressed to become low temperature and low pressure flows into the second heat exchanger 11a, and then is drawn into the compressor 2 via the four-way valve 3.

As the refrigerant circuit operates, the desiccant rotor 14 starts rotating by the rotation device. Furthermore, the first blower means 13 and the second blower means 13a start operating, and the air flows through the first air flow path and the second air flow path.

Referring to FIG. 2 again, the conditions of the air in each air flow path will be described. In FIG. 2, the same numbers as those used for the dehumidification operation are used for simplification of the figure, but this does not mean that the conditions of the air are the same in the dehumidification operation and the humidification operation.

In the first air flow path, the indoor air in condition 1 in the figure is drawn in from the first air inlet 20 and flows into the first heat exchanger 11. At this time, the heat medium at high temperature is flowing through the first heat exchanger 11, so that the air is heated and changes to condition 4 in the figure.

The air that has passed through the first heat exchanger 11 flows into the desiccant rotor 14. The desiccant rotor 14 has adsorbed moisture. Therefore, in the first air flow path, the desiccant rotor 14 desorbs the moisture that has been adsorbed. This increases the absolute humidity of the air, and the temperature of the air decreases due to desorption heat. Due to the above action, the air changes from condition 4 to condition 5 in the figure. Then, the air is blown out into the room from the first air outlet 21.

In the second air flow path, the conditions of the air change as described below. The indoor air in condition 1 in the figure is drawn in from the second air inlet 20a, and flows into the second heat exchanger 11a. At this time, the heat medium at low temperature is flowing through the second heat exchanger 11a, so that the air is cooled and changes to condition 2 in FIG. 2.

The air that has passed through the second heat exchanger 11a flows into the desiccant rotor 14. The desiccant rotor 14 is in a dry state and adsorbs moisture in the air. This reduces the absolute humidity of the air, and the temperature rises due to adsorption heat. Due to the above action, the air changes from condition 2 to condition 3 in the figure. The air that has passed through the desiccant rotor 14 is discharged to the outside from the second air outlet 21a.

As described above, the ventilator 100 in this embodiment can perform the dehumidification operation and the humidification operation. Furthermore, the ventilator 100 has the following effects.

The ventilator 100 includes the desiccant rotor 14, and is a ventilator that performs type 3 ventilation. To install the ventilator 100, it is only necessary to make a hole in a wall 1000 at a place corresponding to the second air outlet 21a. In contrast to this, a conventional ventilator with desiccant material is a ventilator that performs type 1 ventilation, so that it is necessary to arrange in installation that both a supply-side air flow path and an exhaust-side air flow path communicate with indoor and outdoor spaces.

Therefore, the ventilator 100 can be installed with less work in comparison with the conventional ventilator. In addition, the installation method of the ventilator 100 is roughly the same as that of a conventional air conditioner, so that common work-related knowledge and skill can be utilized.

In the conventional ventilator, a heat exchanger is placed downstream of the desiccant material. In the ventilator 100, the heat exchanger 11 is placed upstream of the desiccant rotor 14 in both the first and second air flow paths regardless of whether the dehumidification operation or the humidification operation is performed.

In more detail, when moisture adsorbs to the desiccant rotor 14, the air is cooled in the heat exchanger 11 located upstream, and when moisture desorbs from the desiccant rotor 14, the air is heated by the heat exchanger 11 located upstream. This increases the moisture adsorption and desorption efficiency of the desiccant rotor 14. Therefore, the ventilator 100 can perform more reliable dehumidification and humidification. In addition, due to the high efficiency of the desiccant rotor 14, the desiccant rotor 14 can be made smaller, improving installation workability of the case 10.

In the conventional ventilator, in addition to dehumidification by the desiccant rotor, cooling dehumidification by the heat exchanger is also performed. Therefore, in the conventional ventilator, if the amount of dehumidification is to be increased, the temperature of the heat exchanger needs to be lowered. As a result, the ratio of capability to sensible heat of the ventilator is large, so that a decrease in the room temperature may occur or control to prevent a decrease in the room temperature (thermo-off) may occur. In contrast to this, the efficiency of the desiccant rotor 14 is high in the ventilator 100, so that the ratio of capability to sensible heat is small and dehumidification can be performed while suppressing a decrease in the room temperature.

The ventilator 100 has been described above. However, the above configuration and operation is an example, and each element or all elements of the ventilator 100 can be replaced with equivalent elements. Alternatively, elements may be added as necessary.

For example, a temperature sensor and a humidity sensor may be attached to any place in the ventilator 100. In this case, the temperature sensor and the humidity sensor are connected with the control device (not illustrated) and transmit and receive signals.

As an example, a case will be considered where the temperature sensor and the humidity sensor are attached to the first air inlet 20. By the action of the temperature sensor and the humidity sensor, the temperature and humidity of the indoor air drawn in from the first air inlet 20 can be detected.

In this case, in the dehumidification operation the temperature of the first heat exchanger 11 can be controlled depending on the condition of the indoor air. More specifically, the condition of the indoor air is first found out based on detection results of the temperature sensor and the humidity sensor. Then, a temperature is calculated that will cause the relative humidity to be equal to or above a predetermined value (for example, 80%) when the temperature of the indoor air is lowered. Then, the temperature of the first heat exchanger 11 is set to a temperature equal to or lower than the calculated temperature.

By setting the temperature of the first heat exchanger 11 as described above, the relative humidity of the air flowing into the desiccant rotor 14 increases. The moisture adsorption efficiency of the desiccant rotor 14 improves as the relative humidity of the inflowing air is higher, so that more moisture can be removed in the desiccant rotor 14.

Also in the humidification operation, the temperature of the first heat exchanger 11 can be controlled depending on the condition of the indoor air. When the air flows into the desiccant rotor 14 that has adsorbed moisture, the moisture desorption efficiency of the desiccant rotor 14 increases as the temperature of the air is higher. Therefore, in order to set the temperature of the air flowing into the desiccant rotor 14 to a predetermined temperature (for example, 40° C.), the temperature of the first heat exchanger 11 may be controlled to be equal to or higher than the above temperature.

In the above case, the temperature sensor and the humidity sensor are attached to the first air inlet 20, but a temperature sensor and a humidity sensor may be attached to the second air inlet 20a. In this case, in the dehumidification operation, by controlling the temperature of the second heat exchanger 11a so that the temperature of the air is equal to or higher than a predetermined value (for example, 40° C.), the moisture desorption efficiency of the desiccant rotor 14 can be enhanced. On the other hand, in the humidification operation, by controlling the temperature of the second heat exchanger 11a so that the relative humidity of the air is equal to or higher than a predetermined value (for example, 80%), the moisture adsorption efficiency of the desiccant rotor 14 can be enhanced.

As another variation, filters to remove dust contained in the air may be attached to the first air inlet 20 and the second air inlet 20a. By providing the filters, dust can be prevented from entering the case 10 so as to prevent performance deterioration of the first heat exchanger 11, the second heat exchanger 11a, and the desiccant rotor 14 due to adhesion of dust.

As still another variation, the form of the case 10 may be changed. Specifically, in FIG. 1, the case 10 is formed to be attached to the wall 1000, but the case 10 may be formed to be mounted on the ceiling or placed on the floor. Alternatively, the ventilator 100 may be configured such that the outdoor unit 1 and the case 10 are integrated, and may be placed on the indoor side. Furthermore, the air is discharged from the hole provided in the wall 1000 in the second air flow path, and an exhaust duct may be provided at this hole.

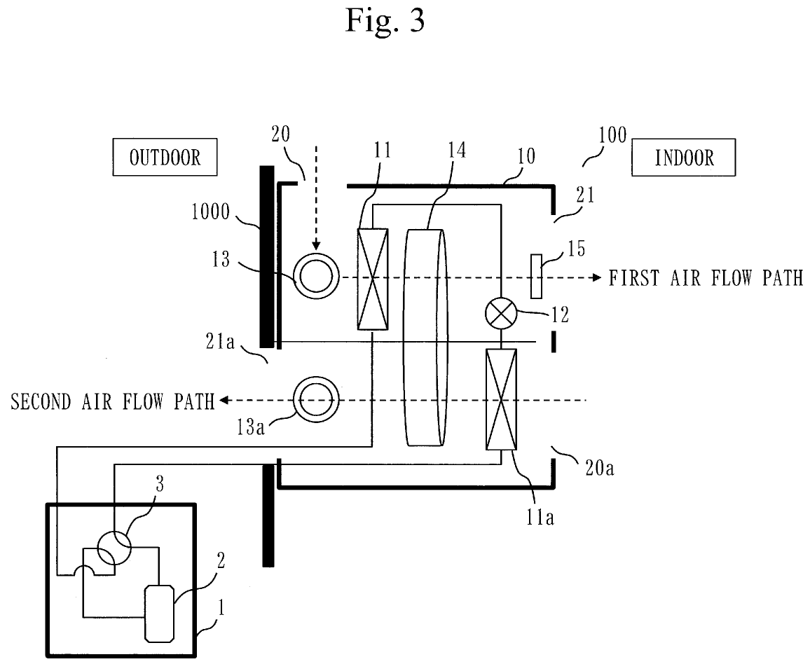

Furthermore, a humidification device may be added to the ventilator 100. FIG. 3 is a figure illustrating a configuration of the ventilator 100 when a humidifier 15 is added. As illustrated in FIG. 3, the humidifier 15 is placed downstream of the desiccant rotor 14 in the first air flow path.

Adding the humidifier 15 increases the humidification performance of the ventilator 100. Since the humidifier 15 is placed downstream of the desiccant rotor 14, it does not increase the humidity of the air flowing into the desiccant rotor 14 and does not reduce the efficiency of the desiccant rotor 14. As the humidifier 15, any water-supply humidification device can be used.

Furthermore, the first blower means 13 and the second blower means 13a are arranged vertically in the case 10, but the first blower means 13 and the second blower means 13a may be arranged horizontally.

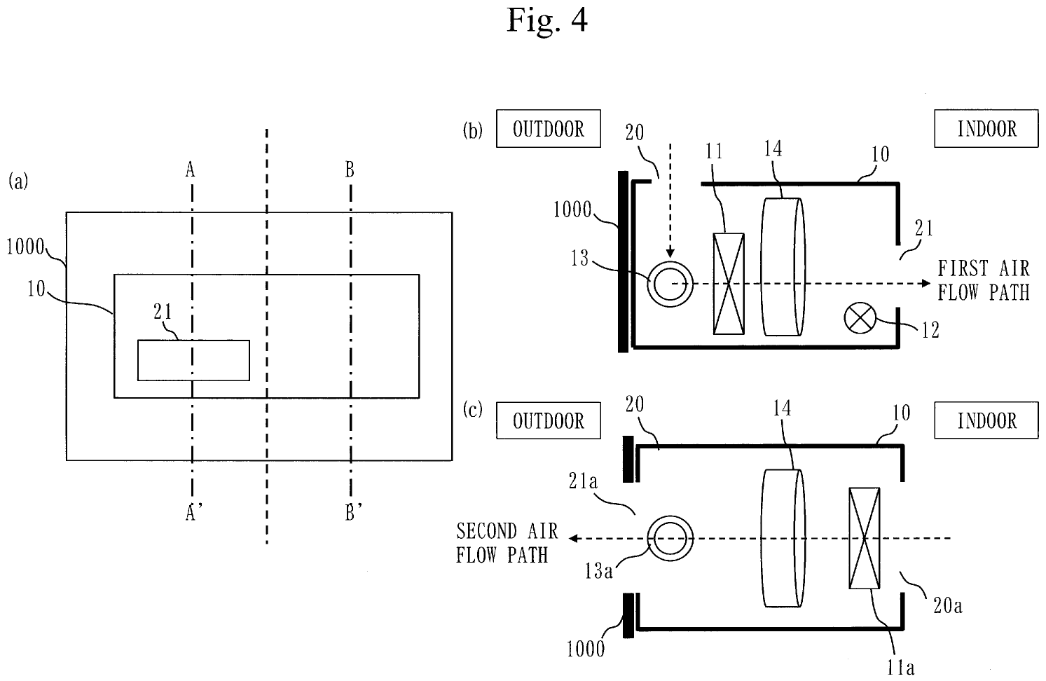

In FIG. 4, (a), (b), and (c) are diagrams illustrating a variation of the case 10, where (a) of FIG. 4 is a front view of the case 10, and (b) of FIG. 4 and (c) of FIG. 4 are cross-sectional views of the case 10 along line A-A′ and line B-B′ indicated in (a) of FIG. 4, respectively.

On the left side of (a) of FIG. 4 of the case 10, the first heat exchanger 11, the first expansion means 12, the first blower means 13, and at least of a portion of the desiccant rotor 14 are placed, as indicated in (b) of FIG. 4. In addition, the first air inlet 20 and the first air outlet 21 are formed on the left side of the case 10, and thus the first air flow path is also located on the left side.

On the right side of (a) of FIG. 4 of the case 10, the second heat exchanger 11a, the second blower means 13a, and at least a portion of the desiccant rotor 14 are placed, as indicated in (c) of FIG. 4. In addition, the second air inlet 20a and the second air outlet 21a are formed on the right side of the case 10, and thus the second air flow path is also located on the right side.

Although not illustrated in (b) of FIG. 4 and (c) of FIG. 4, the first heat exchanger 11, the first expansion means 12, and the second heat exchanger 11a are connected by pipes in substantially the same manner as in FIG. 1. The case 10 and the outdoor unit 1 are connected via the second air outlet 21a by a pipe that extends to the inside of the room and to the outside.

By adopting the configuration of the case 10 as illustrated in (a), (b), and (c) of FIG. 4, the width of the case 10 in the vertical direction is reduced, allowing more diverse placement methods in the room.

Furthermore, in the first air flow path and the second air flow path of the ventilator 100, a bypass air flow path that bypasses the desiccant rotor 14 and a damper to switch the air flow path may be provided. In such a case, when dehumidification and humidification are not required, the air flow path is switched so as to bypass the desiccant rotor 14. By bypassing the desiccant rotor 14, the ventilation resistance is greatly reduced, so that the air flow volume and ventilation amount of the ventilator 100 can be increased.

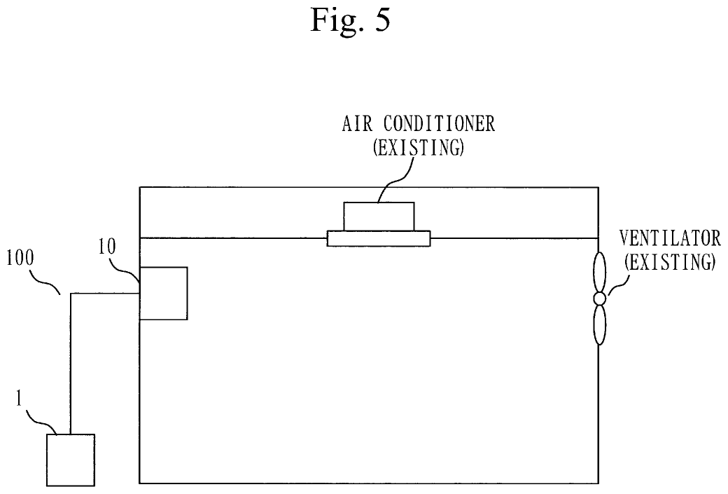

The ventilator 100 can be installed together with any air conditioner and ventilator. FIG. 5 is a figure illustrating an example of an installation situation of the ventilator 100. In FIG. 5, an existing air conditioner, an existing ventilator, and the ventilator 100 are installed in one space

When the ventilator 100 is installed together with an existing device as in FIG. 5, the ventilator 100 may be operated in conjunction with the existing device. For example, when the cooling load and heating load of an existing air conditioner is large, the ventilator 100 is operated after the desiccant rotor 14 is stopped. By operating the ventilator 100 in this way, the load on the existing air conditioner can be distributed. In general, an air conditioner is more efficient as the load is smaller. Therefore, when the load is large, energy saving can be expected by operating the ventilator 100 and the existing air conditioner simultaneously.

### Embodiment 2

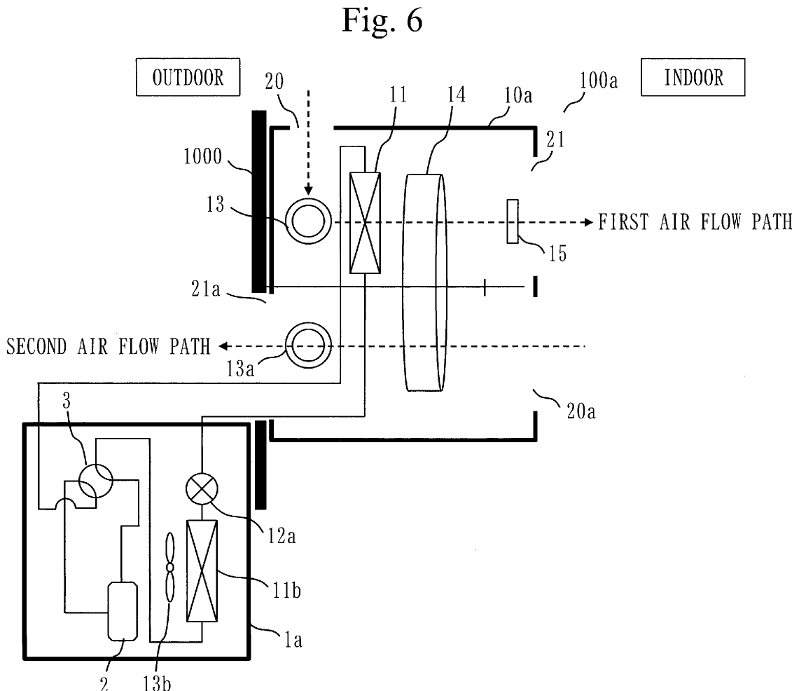

Referring to FIGS. 6 to 8, Embodiment 2 of the present disclosure will be described. The configuration of a ventilator 100a of this embodiment is roughly the same as the configuration of the ventilator 100 of Embodiment 1, but some components and functions are different. With regard to the ventilator 100a according to this embodiment, differences from Embodiment 1 will be mainly described below. Portions for which description is omitted are the same as in Embodiment 1.

FIG. 6 is a figure illustrating the configuration of the ventilator 100a in this embodiment. Compared with FIG. 1 of Embodiment 1, FIG. 6 differs in that a third heat exchanger 11b, second expansion means 12a, and third blower means 13b are placed in an outdoor unit 1a. Another difference is that the humidifier 15 is placed and the second heat exchanger 11a and the first expansion means 12 are not placed in the case 10a.

The third heat exchanger 11b is, for example, a finned tube heat exchanger, like the first heat exchanger 11 and the second heat exchanger 11a. The third heat exchanger 11b may be a flat tube heat exchanger composed of flat heat transfer pipes and plate fins, or may be a finless heat exchanger composed of heat transfer pipes without fins.

The second expansion means 12a is, for example, a solenoid valve whose opening degree can be controlled, like the first expansion means 12. The second expansion means 12a decompresses an inflowing refrigerant at high pressure to the refrigerant at low pressure.

The third blower means 13b draws in outdoor air into the outdoor unit 1a, and causes the outdoor air to flow into the third heat exchanger 11b. After exchanging heat with the third heat exchanger 11b, the outdoor air is discharged to the outside of the outdoor unit 1a. As the third blower means 13b, any means can be used such as a sirocco fan, a propeller fan, or a cross flow fan.

As the humidifier 15, any water-supply humidification device as described in the variation in Embodiment 1 can be used. As illustrated in FIG. 6, the humidifier 15 is located downstream of the desiccant rotor 14. The humidifier 15 operates to humidify the air when the ventilator 100a performs the humidification operation.

The operation of the ventilator 100a will now be described. In the following description, the dehumidification operation of the ventilator 100a will be described first, and then the humidification operation will be described.

In the dehumidification operation, the heat medium at high temperature and high pressure discharged from the compressor 2 flows into the four-way valve 3 and the third heat exchanger 11b. The heat medium that has flowed out from the third heat exchanger 11b is decompressed in the second expansion means 12a to become low temperature and low pressure, and then flows into the first heat exchanger 11. The heat medium that has flowed out from the first heat exchanger 11 is drawn into the compressor 2 again via the four-way valve 3.

At this time, the first blower means 13, the second blower means 13a, and the third blower means 13b start operating. The third blower means 13b causes the air to flow into the third heat exchanger 11b. The desiccant rotor 14 starts rotating by the rotation device (not illustrated). The conditions of the air in each air flow path will be described below.

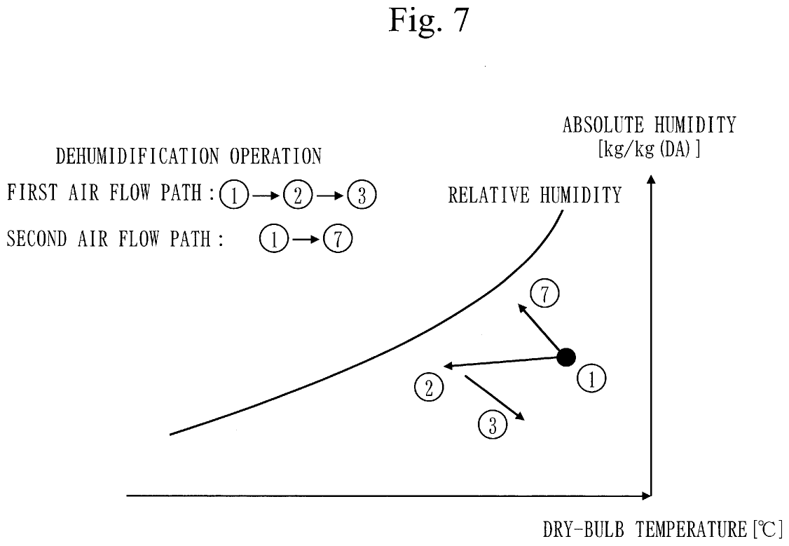

FIG. 7 is a psychrometric chart indicating the conditions of the air in the first and second air flow paths in the dehumidification operation. In FIG. 7, when the conditions of the air change in the same process as in Embodiment 1, the same numbers as those in FIG. 2 are indicated.

In the first air flow path, the indoor air in condition 1 in FIG. 7 is drawn in from the first air inlet 20, and flows into the first heat exchanger 11 whose temperature is low. Therefore, the inflowing indoor air is cooled and changes to condition 2, as in Embodiment 1.

The air that has passed through the first heat exchanger 11 flows into the desiccant rotor 14. The desiccant rotor 14 adsorbs moisture contained in the air, as in Embodiment 1. This dehumidifies the air, and the air changes from condition 2 to condition 3 in FIG. 7. Then, the air is blown into the room from the first air outlet 21.

In the second air flow path, the conditions of the air change as described below. The indoor air in condition 1 in FIG. 7 is drawn in from the second air inlet 20a and flows into the desiccant rotor 14. In the desiccant rotor 14, the moisture adsorbed in the first air flow path is desorbed.

This increases the humidity of the air passing through the desiccant rotor 14, and the temperature of the air decreases due to desorption heat. Therefore, as indicated in FIG. 7, the air changes from condition 1 to condition 7. The air that has passed through the desiccant rotor 14 is discharged to the outside from the second air outlet 21a.

The ventilator 100a performs the dehumidification operation by the above operation. The humidification operation of the ventilator 100a will be described next.

In the humidification operation, the heat medium at high temperature and high pressure discharged from the compressor 2 flows into the four-way valve 3 and the first heat exchanger 11. The heat medium that has flowed out from the first heat exchanger 11 flows into the second expansion means 12a to be decompressed and become the heat medium at low temperature and low pressure. Then, the heat medium flows into the third heat exchanger 11b, and then is drawn into the compressor 2 again via the four-way valve 3.

Furthermore, the first blower means 13, the second blower means 13a, and the third blower means 13b start operating. This causes the air to flow through the first air flow path, the second air flow path, and the third heat exchanger 11b.

In the humidification operation of the ventilator 100a, the desiccant rotor 14 does not rotate. Therefore, the desiccant rotor 14 does not adsorb and desorb moisture. As will be described later, the air is humidified by the humidifier 15 in the humidification operation of the ventilator 100a.

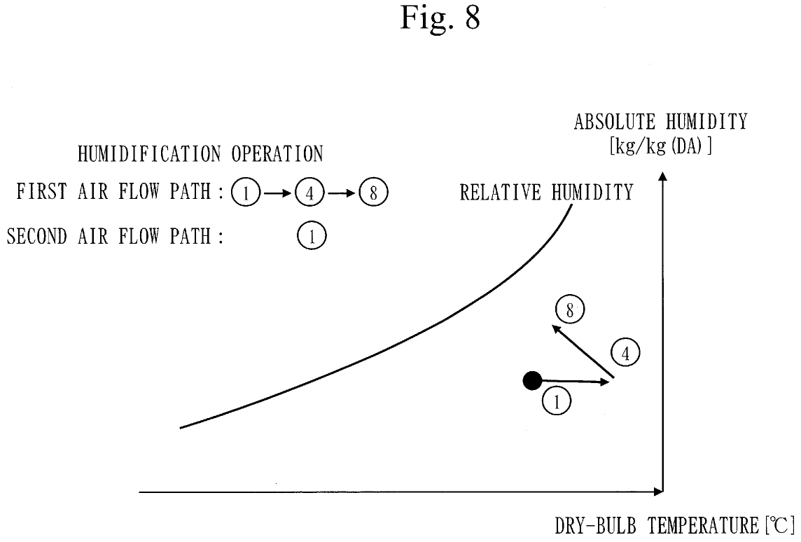

Referring to FIG. 8, the conditions of the air in each air flow path will be described.

In the first air flow path, the indoor air in condition 1 in FIG. 8 is drawn in from the first air inlet 20 and flows into the first heat exchanger 11 whose temperature is high. As a result, the inflowing indoor air is heated and changes to condition 4, as in Embodiment 1.

The air that has flowed out from the first heat exchanger 11 passes through the desiccant rotor 14, which is not operating, and flows into the humidifier 15. As a result, the air is humidified. At this time, the temperature of the air changes depending on the temperature of moisture supplied from the humidifier 15. If the temperature of the moisture is lower than the temperature of the air, the temperature of the air decreases. In this case, the air changes from condition 4 to condition 8, as indicated in FIG. 8.

In the second air flow path, there is no heat exchanger and the desiccant rotor 14 is not operating. Therefore, in the second air flow path in the humidification operation, the condition of the air does not change, and the air that is drawn in from the second air inlet 20a is discharged to the outside from the second air outlet 21a without any change in the condition.

As described above, the ventilator 100a in this embodiment can perform the dehumidification operation and the humidification operation. When compared with the ventilator 100 of Embodiment 1, the ventilator 100a has the following effects.

The second heat exchanger 11a is not placed in the case 10a of the ventilator 100a. Therefore, the size of the case 10a can be reduced, making it easier to install the ventilator 100a.

In addition, the first expansion means 12 is not also placed in the case 10a. Therefore, the first expansion means 12 is less likely to generate noise and make a user feel uncomfortable.

### Embodiment 3

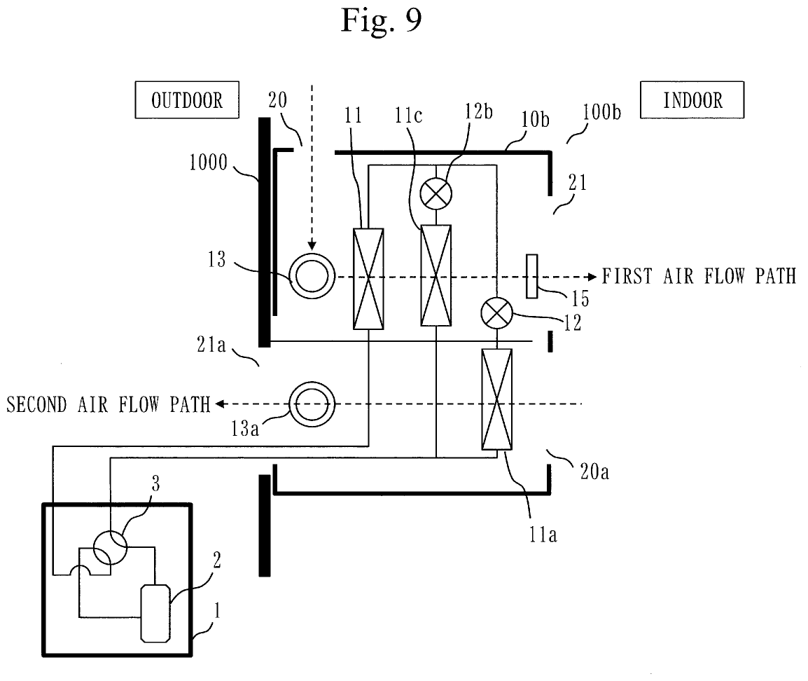

Referring to FIGS. 9 to 11, Embodiment 3 of the present disclosure will be described. The configuration of a ventilator 100b in this embodiment is roughly the same as the configuration of the ventilator 100 in Embodiment 1, but some components and functions are different. With regard to the ventilator 100b according to this embodiment, differences from Embodiment 1 will be mainly described below. Portions for which description is omitted are the same as in Embodiment 1.

FIG. 9 is a figure illustrating the configuration of the ventilator 100b in this embodiment. Compared with FIG. 1 of Embodiment 1, FIG. 9 differs in that a fourth heat exchanger 11c, third expansion means 12b, and the humidifier 15 are placed in a case 10b. In addition, the desiccant rotor 14 is not placed in the case 10b. The configuration of the outdoor unit 1 is substantially the same as that in Embodiment 1.

The fourth heat exchanger 11c is, for example, a finned tube heat exchanger, like the first heat exchanger 11. The shape of the fourth heat exchanger 11c, that is, the number of paths, arrangement of the paths, the shape of the fins, and so on, may be the same as or different from that of the first heat exchanger 11. As illustrated in FIG. 9, the fourth heat exchanger 11c is located downstream of the first heat exchanger 11 in the first air flow path.

The third expansion means 12b is, for example, a solenoid valve whose opening degree can be controlled, like the first expansion means 12. The third expansion means 12b is placed between the first heat exchanger 11 and the fourth heat exchanger 11c in the refrigerant circuit. It is desirable that the third expansion means 12b be not located between the first heat exchanger 11 and the second heat exchanger 11a in the refrigerant circuit. This is because in the dehumidification operation to be described later, the pressure in the second heat exchanger 11a and the pressure in the fourth heat exchanger 11c can be independently controlled, so that the operating range of the ventilator 100b is widened.

The humidifier 15 is any water-supply humidification device as described in the variation of Embodiment 1. The humidifier 15 operates to humidify the air when the ventilator 100b performs the humidification operation.

The operation of the ventilator 100b will now be described. In the following, the dehumidification operation of the ventilator 100b will be described first, and then the humidification operation will be described.

In the dehumidification operation, the heat medium at high temperature and high pressure discharged from the compressor 2 passes through the four-way valve 3 and flows into the second heat exchanger 11a and the fourth heat exchanger 11c. Therefore, the heat medium at high temperature and high pressure flows through the second heat exchanger 11a and the fourth heat exchanger 11c. The heat medium that has passed through the second heat exchanger 11a flows into the first expansion means 12, and the heat medium that has passed through the fourth heat exchanger 11c flows into the third expansion means 12b.

In the first expansion means 12 and the third expansion means 12b, the heat medium is decompressed to become low temperature and low pressure. Then, the flows of the heat medium join together in the refrigerant circuit to flow into the first heat exchanger 11. This lowers the temperature of the first heat exchanger 11, and cooling dehumidification is performed in the first heat exchanger 11, as will be described later.

The heat medium that has flowed out from the first heat exchanger 11 is drawn into the compressor 2 again via the four-way valve 3. As the refrigerant circuit operates as described above, the first blower means 13 and the second blower means 13a start operating, and the air flows through the first air flow path and the second air flow path.

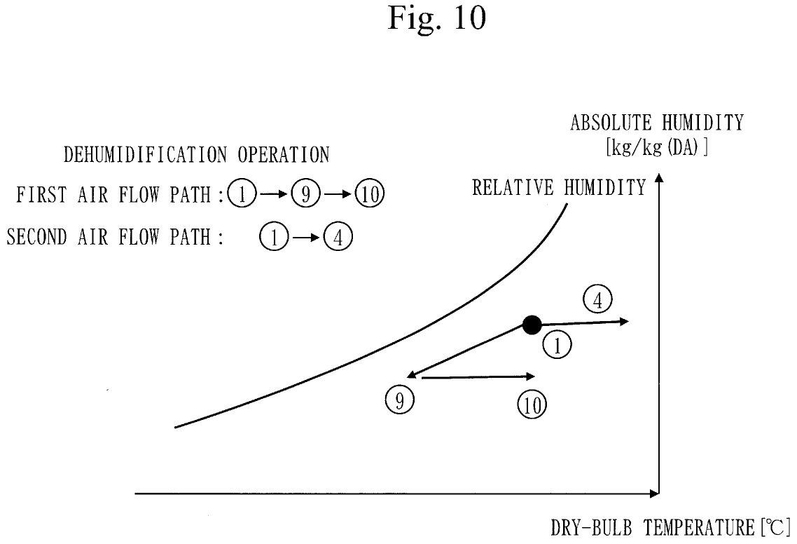

The conditions of the air in each air flow path will be described next. FIG. 10 is a psychrometric chart indicating the conditions of the air in the first and second air flow paths in the dehumidification operation. In FIG. 10, when the air changes in the same manner as in Embodiment 1, the same numbers as those in FIG. 2 are indicated.

In the first air flow path, the indoor air in condition 1 in FIG. 10 is drawn in from the first air inlet 20 and flows into the first heat exchanger 11 whose temperature is low. In the first heat exchanger 11, the air is cooled and dehumidified and becomes the condition indicated as 9 in FIG. 10.

Looking at the changes in the condition of the air at this time in more detail, the temperature of the air flowing into the first heat exchanger 11 decreases first. As the temperature decreases, the relative humidity increases, and when it reaches close to 100%, condensation begins. When moisture adheres to the surface of the first heat exchanger 11 due to condensation, the absolute humidity of the air decreases by the amount of the moisture. This results in dehumidification of the air.

The air that has been cooled and dehumidified in the first heat exchanger 11 as described above then flows into the fourth heat exchanger 11c. In the dehumidification operation, the heat medium at high temperature and high pressure is flowing through the fourth heat exchanger 11c. Therefore, the temperature of the air that has flowed into the fourth heat exchanger 11c rises. The relative humidity decreases as the temperature of the air rises. As a result, the condition of the air changes from condition 9 to condition 10 in FIG. 10. The air thus conditioned is blown out from the first air outlet 21.

In the second air flow path, the conditions of the air change as described below. The indoor air in condition 1 in FIG. 10 is drawn in from the second air inlet 20a and flows into the second heat exchanger 11a. The heat medium at high temperature and high pressure is flowing through the second heat exchanger 11a, so that the temperature of the air that has flowed into the second heat exchanger 11a rises. As a result, the air changes from condition 1 to condition 4, as in Embodiment 1. The air that has passed through the second heat exchanger 11a is discharged to the outside from the second air outlet 21a.

The ventilator 100b performs the dehumidification operation by the above operation. The humidification operation of the ventilator 100b will be described next.

In the humidification operation, the heat medium discharged from the compressor 2 flows into the first heat exchanger 11 via the four-way valve 3. The heat medium that has flowed out from the first heat exchanger 11 is decompressed to become low temperature and low pressure in the first expansion means 12 and flows into the second heat exchanger 11a. The heat medium that has flowed out from the second heat exchanger 11a is drawn into the compressor 2 again via the four-way valve 3.

In the humidification operation, the third expansion means 12b is closed and the heat medium does not flow through it. Therefore, the heat medium does not also flow through the fourth heat exchanger 11c located downstream of the third expansion means 12b.

At this time, the first blower means 13 and the second blower means 13a start operating. This causes the air to flow through the first air flow path and the second air flow path.

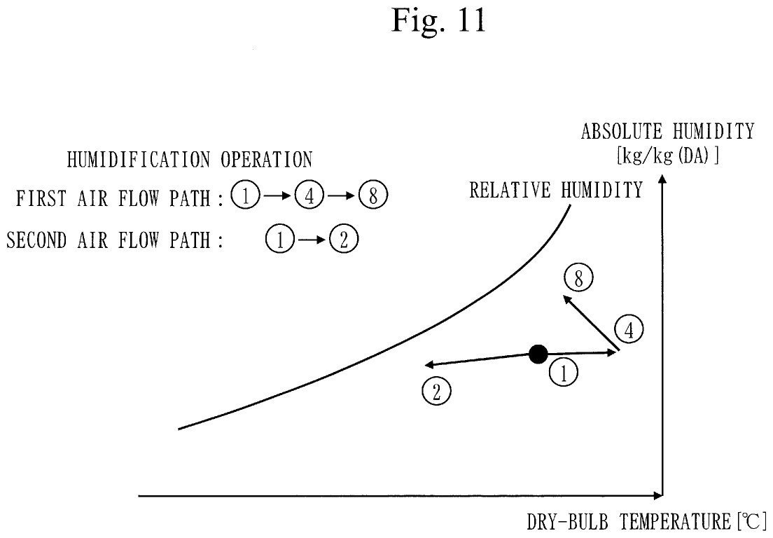

Referring to FIG. 11, the conditions of the air in each air flow path will be described.

In the first air flow path, the indoor air in condition 1 in FIG. 11 is drawn in from the first air inlet 20 and flows into the first heat exchanger 11 whose temperature is high. As a result, the air is heated and changes to condition 4, as in Embodiments 1 and 2.

The air that has passed through the first heat exchanger 11 passes through the fourth heat exchanger 11c and flows into the humidifier 15. The air is humidified by the humidifier 15, and the condition of the air changes from 4 to 8 as indicated in FIG. 11. The air thus conditioned is blown out into the room from the first air outlet 21.

In the second air flow path, the air that has been drawn in from the second air inlet 20a flows into the second heat exchanger 11a whose temperature is low. This causes the temperature of the air to decrease, and when the relative humidity increases, the humidity also decreases due to condensation. The air that has flowed out from the second heat exchanger 11a is discharged to the outside from the second air outlet 21a.

As described above, the ventilator 100b in this embodiment can perform the dehumidification operation and the humidification operation. When compared with the ventilator 100 of Embodiment 1, the ventilator 100b has the following effects.

The ventilator 100b is capable of the dehumidification operation and the humidification operation without placing the desiccant rotor 14 in the case 10b. This eliminates the need for maintenance of the desiccant rotor 14 and reduces the cost and effort required for maintenance of the ventilator 100b.

In addition, since the desiccant rotor 14, which has a large volume, is not placed in the case 10b, the volume of the case 10b is reduced, making it easier to install the ventilator 100b.

### Embodiment 4

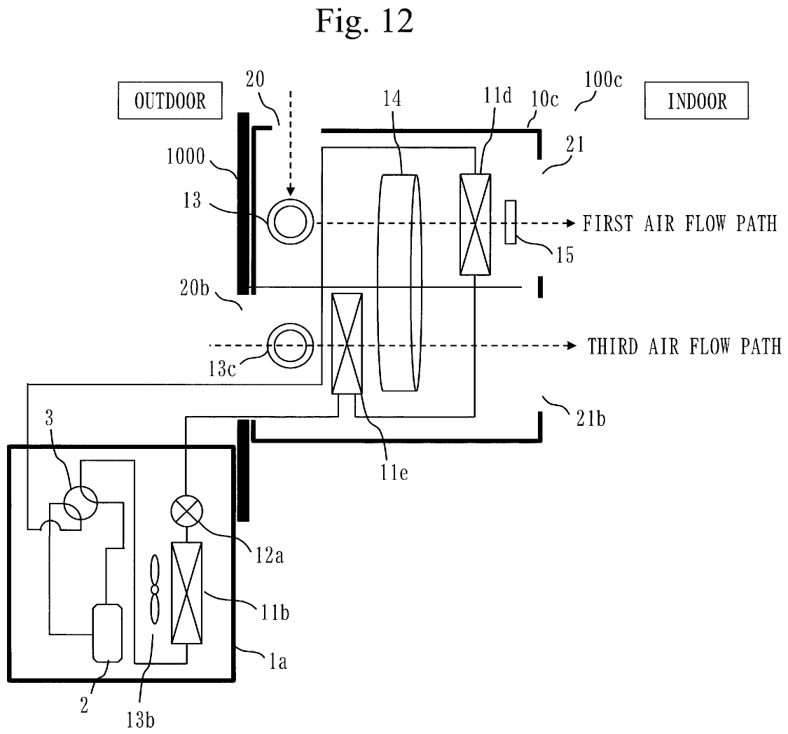

Referring to FIGS. 12 to 14, Embodiment 4 of the present disclosure will be described. The configuration of a ventilator 100c in this embodiment is roughly the same as the configuration of the ventilator 100a in Embodiment 2, but some components and functions are different. With regard to the ventilator 100c according to this embodiment, differences from Embodiment 2 will be mainly described below. Portions for which description is omitted are the same as in Embodiment 2.

FIG. 12 is a figure illustrating the configuration of the ventilator 100c in this embodiment. Compared with FIG. 6 of Embodiment 2, FIG. 12 differs in that a fifth heat exchanger lid, a sixth heat exchanger lie, and fourth blower means 13c are placed in a case 10c. Furthermore, another difference is that a third air inlet 20b and a third air outlet 21b are provided in the case 10c. The configuration of the outdoor unit 1a is substantially the same as that in Embodiment 2.

The fifth heat exchanger lid and the sixth heat exchanger 11e are, for example, finned tube heat exchangers, like the first heat exchanger 11. The shape of each of the fifth heat exchanger 11d and the sixth heat exchanger 11e, that is, the number of paths, arrangement of the paths, the shape of the fins, and so on, may be the same as or different from that of the first heat exchanger 11.

In the case 10c, the third air inlet 20b and the third air outlet 21b are provided. The shape and position of the third air inlet 20b may be the same as those of the second air outlet 21a, and the shape and position of the third air outlet 21b may be the same as those of the second air inlet 20a. The direction in which the air flows is different here, so that they will be described as different components for convenience. As for an air flow path, an air flow path connecting the third air inlet 20b and the third air outlet 21b will be referred to as a third air flow path.

In the first air flow path, the fifth heat exchanger lid is located downstream of the desiccant rotor 14. Furthermore, in the third air flow path, the sixth heat exchanger 11e is located upstream of the desiccant rotor 14.

The fourth blower means 13c draws in the outdoor air from the third air inlet 20b and causes it to flow into the sixth heat exchanger 11e and the desiccant rotor 14. After exchanging heat in the sixth heat exchanger 11e, the outdoor air goes through humidity control in the desiccant rotor 14 and is blown out to the outside from the third air outlet 21b. Therefore, in the ventilator 100c, ventilation is performed by type 2 ventilation, in which the outdoor air is taken into the room from the third air inlet 20b. As the fourth blower means 13c, any means can be used such as a sirocco fan, a propeller fan, or a cross flow fan.

The operation of the ventilator 100c will now be described. In the following description, the dehumidification operation of the ventilator 100c will be described first, and then the humidification operation will be described.

In the dehumidification operation, the heat medium at high temperature and high pressure discharged from the compressor 2 flows through the four-way valve 3, the third heat exchanger 11b, and the second expansion means 12a. The heat medium is decompressed to become low temperature and low pressure in the second expansion means 12a and flows into the sixth heat exchanger 11e. Then, the heat medium flows into the fifth heat exchanger 11d, and is finally drawn into the compressor 2 via the four-way valve 3.

As the refrigerant circuit operates as described above, the first blower means 13, the third blower means 13b, and the fourth blower means 13c also operate. The first blower means 13 causes the air to flow through the first air flow path, the third blower means 13b causes the air to flow through the third heat exchanger 11b, and the fourth blower means 13c causes the air to flow through the third air flow path. The desiccant rotor 14 rotates by the rotation device (not illustrated).

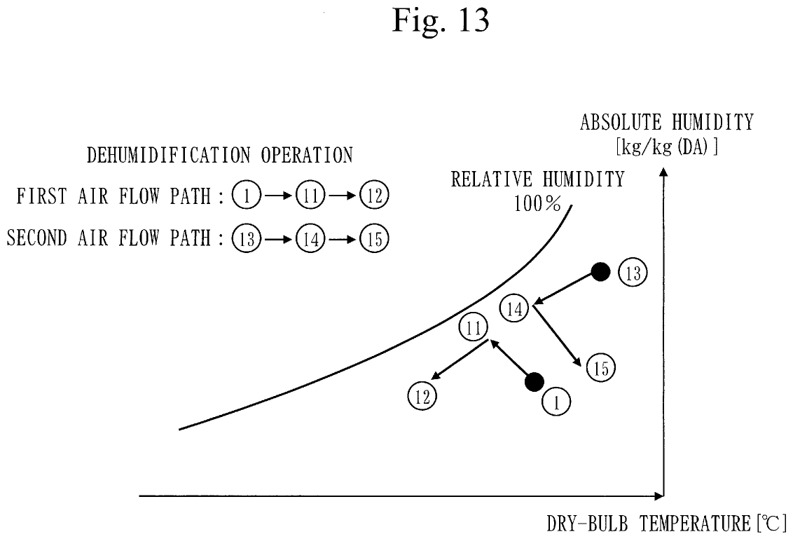

The conditions of the air in each air flow path will be described next. FIG. 13 is a psychrometric chart indicating the conditions of the air in the first and third air flow paths in the dehumidification operation.

In the first air flow path, the indoor air in condition 1 in FIG. 13 is drawn in from the first air inlet 20 and flows into the desiccant rotor 14. In the first air flow path, moisture desorbs from the desiccant rotor 14 and the absolute humidity of the air increases. In addition, the temperature of the air decreases due to desorption heat in the desiccant rotor 14. As a result, the air changes from condition 1 to condition 11.

The air that has flowed out from the desiccant rotor 14 flows into the fifth heat exchanger lid whose temperature is low. In the fifth heat exchanger lid, the temperature of the air decreases, and when the relative humidity increases close to 100%, the absolute humidity also decreases due to condensation. As a result, the air changes to condition 12 in FIG. 13. The air thus conditioned is blown into the room from the first air outlet 21.

In the third air flow path, the conditions of the air change as described below. First, the outdoor air is drawn in from the third air inlet 20b. In the season when the dehumidification operation is performed, the outdoor air is high temperature and high humidity as indicated by 13 in FIG. 13.

The outdoor air that has been drawn in from the third air inlet 20b flows into the sixth heat exchanger 11e whose temperature is low. In the sixth heat exchanger 11e, the air is cooled and the temperature decreases, and when the relative humidity becomes close to 100%, the absolute humidity decreases due to condensation. As a result, the outdoor air is in a condition indicated by 14.

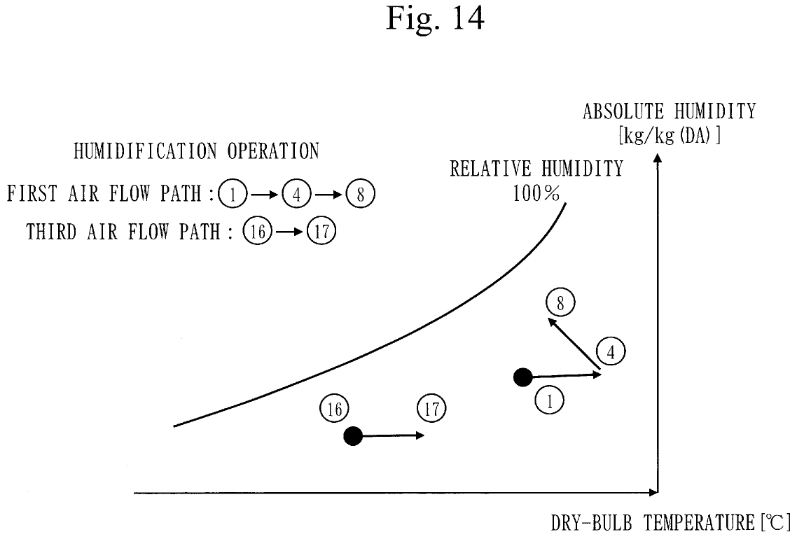

The air that has flowed out from the sixth heat exchanger 11e flows into the desiccant rotor 14. In the third air flow path, the desiccant rotor 14 adsorbs moisture contained in the air. This lowers the absolute humidity of the air, and furthermore the temperature of the air rises due to adsorption heat. As a result, the air is conditioned to condition 15 in FIG. 14 and is blown into the room from the third air outlet 21b.

The ventilator 100c performs the dehumidification operation by the above operation. In the dehumidification operation, mixed air composed of the air blown out from the first air outlet 21 and the air blown out from the third air outlet 21b is blown into the room.

In more detail, the condition of the air blown into the room is indicated by a point obtained by dividing the line segment connecting 12 and 15 in FIG. 13 based on the inverse ratio of the amounts of the air blown out from the two air outlets. For example, when the ratio of the amount of the air blown out from the first air outlet 21 to the amount of the air blown out from the third air outlet 21b is 7 to 3, the condition of the mixed air is indicated by a point obtained by dividing the line segment connecting 12 and 15 in FIG. 13 into 10 segments and moving 3 segments from 12 toward 15.

The humidification operation of the ventilator 100c will be described next.

In the humidification operation, the heat medium at high temperature and high pressure discharged from the compressor 2 flows, via the four-way valve 3, sequentially through the fifth heat exchanger 11d, the sixth heat exchanger 11e, and the second expansion means 12a. The heat medium that has been decompressed to become low temperature and low pressure in the second expansion means 12a flows into the third heat exchanger 11b, and then is drawn into the compressor 2 via the four-way valve 3.

As the refrigerant circuit operates, the first blower means 13, the third blower means 13b, and the fourth blower means 13c also operate, and cause the air to flow through the first air flow path, the third heat exchanger 11b, and the third air flow path, respectively. In the humidification operation, the desiccant rotor 14 does not operate and humidification is performed in the humidifier 15.

Referring to FIG. 14, the conditions of the air in each air flow path will be described.

In the first air flow path, the indoor air in condition 1 in FIG. 14 is drawn in from the first air inlet 20. The desiccant rotor 14 is not operating, so that the air flows into the fifth heat exchanger lid while remaining in condition 1.

The heat medium at high temperature is flowing through the fifth heat exchanger 11d. Therefore, the temperature of the air that has flowed into the fifth heat exchanger lid rises and the air changes to condition 4.

The air that has flowed out from the fifth heat exchanger 11d is humidified by the humidifier 15. As a result, the air changes to condition 8 in FIG. 14. The air thus conditioned is blown into the room from the first air outlet 21.

In the third air flow path, the air changes as described below. The outdoor air drawn in from the third air inlet 20b is air at low temperature as indicated by 16 in FIG. 14. The outdoor air at low temperature flows into the sixth heat exchanger 11e whose temperature is high, and is heated. As a result, the temperature of the air rises and the air is in a condition indicated by 17 in FIG. 14. The air that has flowed out from the sixth heat exchanger 11e passes through the desiccant rotor 14, which is not operating, and is blown into the room from the third air outlet 21b.

The ventilator 100c performs the humidification operation by the above operation. As in the case of the dehumidification operation, the condition of the air blown into the room in the humidification operation is indicated by a point obtained by dividing the line segment connecting 8 and 17 in FIG. 14 based on the inverse ratio of the amount of the air blown out from the first air outlet 21 to the amount of the air blown out from the third air outlet 21b. For example, when the ratio of the amount of the air blown out from the first air outlet 21 to the amount of the air blown out from the third air outlet 21b is 6 to 4, the condition of the mixed air is indicated by a point obtained by dividing the line segment connecting 8 and 7 in FIG. 14 into 10 segments and moving 4 segments from 8 toward 17.

As described above, the ventilator 100c in this embodiment can perform the dehumidification operation and the humidification operation. When compared with the ventilator 100a of Embodiment 2, the ventilator 100c has the following effects.

The ventilator 100c is a type 2 ventilator, which ventilates the room by supplying air. Therefore, it is possible to maintain the room at positive pressure and to prevent entering of dust into the room from the outside due to opening and closing of a doorway or the like.

The ventilators of the present disclosure have been described above by presenting Embodiments 1 to 4. The embodiments described above are intended to describe the present disclosure, and are not intended to limit the scope of the present disclosure. That is, the scope of the present disclosure is indicated not by the embodiments but by the claims. The embodiments of the present disclosure can be implemented and modified in various manners without departing from the broad spirit and scope of the present disclosure.

### INDUSTRIAL APPLICABILITY

The ventilators of the present disclosure are particularly suitable for installation in spaces that require ventilation.

1. A ventilator comprising:
a case in which a first air flow path connecting two places in an indoor space and a second air flow path connecting the indoor space and an outdoor space are formed;
first blower means placed in the first air flow path;
second blower means that is placed in the second air flow path, and draws in air of the indoor space and blows out air to the outdoor space;
a desiccant rotor that is placed across the first air flow path and the second air flow path, and acts as dehumidification means to remove moisture in air in dehumidification operation, and acts as humidification means to increase moisture in air in humidification operation; and
a first heat exchanger that is placed upstream of the desiccant rotor in the first air flow path, and operated as an evaporator in the dehumidification operation.

2. (canceled)

3. (canceled)

4. (canceled)

5. (canceled)

6. (canceled)

7. The ventilator according to claim 1, further comprising
humidification device of a water-supply type placed downstream of the desiccant rotor in the first air path.

8. The ventilator according to claim 1, further comprising
a second heat exchanger placed upstream of the desiccant rotor in the second air flow path.

9. The ventilator according to claim 1, wherein
the case is a ceiling-mounted type or a wall-mounted type.

10. A ventilator comprising:
a case in which a first air flow path connecting two places in an indoor space and a second air flow path connecting the indoor space and an outdoor space are formed;
first blower means placed in the first air flow path;
second blower means placed in the second air flow path;
a first heat exchanger that operates as an evaporator and acts as dehumidification means to remove moisture in air in dehumidification operation in the first flow path;
a fourth heat exchanger that is placed downstream of the first heat exchanger in the first air flow path, and operates as a condenser in the dehumidification operation; and
a humidification device of a water-supply type that acts as humidification means to increase moisture in air in humidification operation in the first air path.

11. The ventilator according to claim 10, wherein
the first heat exchanger operates as a condenser in the humidification operation,
the ventilator further comprising
a second heat exchanger that operates as an evaporator in the humidification operation in the second flow path.

12. The ventilator according to claim 10, wherein
the humidification device is placed downstream of the first heat exchanger.

13. The ventilator according to claim 11, wherein
the humidification device is placed downstream of the first heat exchanger.

14. A ventilator comprising:
a case in which a first air flow path connecting two places in an indoor space and a third air flow path connecting the indoor space and an outdoor space are formed;
first blower means placed in the first air flow path;
second blower means that is placed in the third air flow path, and draws in air of the outdoor space and blows out air into the indoor space;
a desiccant rotor that is placed across the first air flow path and the third air flow path, and acts as dehumidification means to remove moisture in air in dehumidification operation, and acts as humidification means to increase moisture in air in humidification operation; and
a sixth heat exchanger that is placed upstream of the desiccant rotor in the third air flow path, and operates as an evaporator in the dehumidification operation.

15. The ventilator according to claim 14, further comprising
a fifth heat exchanger that is placed downstream of the desiccant rotor in the first air flow path, and operates as an evaporator in the dehumidification operation.

16. The ventilator according to claim 7, wherein
the case is a ceiling-mounted type or a wall-mounted type.

17. The ventilator according to claim 8, wherein
the case is a ceiling-mounted type or a wall-mounted type.

18. The ventilator according to claim 10, wherein
the case is a ceiling-mounted type or a wall-mounted type.

19. The ventilator according to claim 11, wherein
the case is a ceiling-mounted type or a wall-mounted type.

20. The ventilator according to claim 12, wherein
the case is a ceiling-mounted type or a wall-mounted type.

21. The ventilator according to claim 13, wherein
the case is a ceiling-mounted type or a wall-mounted type.

22. The ventilator according to claim 14, wherein
the case is a ceiling-mounted type or a wall-mounted type.

23. The ventilator according to claim 15, wherein
the case is a ceiling-mounted type or a wall-mounted type.
